(19) United States
(12) Patent Application Publication
(10) Pub. No.: US 2006/0174748 A1
(43) Pub. Date: Aug. 10, 2006

(54) Guitar fret board overlays and method for making overlays

(76) Inventors: Bryan Buhoveckey, Schaumburg, IL (US); Matthew Eric Newman, Schaumburg, IL (US)

Correspondence Address: MCANDREWS HELD & MALLOY, LTD, 500 WEST MADISON STREET, SUITE 3400, CHICAGO, IL, 60661, US

(21) Appl. No.: 11/051,129

(22) Filed: Feb. 4, 2005

(51) Int. Cl. G10D 3/06; G10D 3/04; G10D 1/08

(52) U.S. Cl. 84/314 R

(57) ABSTRACT

One embodiment of the invention is an overlay that includes a sheet comprising a first substantially flat surface and a second substantially flat surface opposite the first surface, an image disposed on the first surface, an adhesive disposed on the second surface, and a backing layer adjacent, and removably adhered to, the second surface, wherein the sheet comprises a plurality of substantially rectangular-frame forming channels that correspond with the image. The sheet may optionally include the substantially rectangular-frame forming channels arranged to define a plurality of neck sections disposed along a longitudinal axis. The plurality of neck sections may optionally have a width along the longitudinal axis and a height perpendicular to the longitudinal axis, and the widths become generally larger while moving along the longitudinal axis from a first end of the neck sections to a second end of the neck sections. The heights may optionally become generally smaller while moving along the longitudinal axis from a first end of the neck sections to a second end of the neck sections. The plurality of neck sections may optionally number, for example, 20, 21, 22 or 23. Another embodiment of the invention includes an image disposed on said second surface. Another embodiment of the invention is a method for creating an overlay sheet.

### RELATED APPLICATIONS

[Not Applicable]

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

The present invention relates to the general field of musical instruments, and in particular to guitars (i.e. acoustic, seven string, six string, bass, five string bass, ten string bass, etc.). The present invention can be used with many types of instruments, and can be adapted thereto. Some examples of current neck aesthetics can be described as inlays, which are described briefly below.

The love for music is a passionate thing, with interests in so many types of music one can almost define a personality by their collection of music. The ability to take one step further and give personality to the instrument is a goal of the invention to provide, and the invention described herein can be manufactured for just a fraction of the costs of current products.

Currently, when one wishes to achieve a custom pattern on one's musical instrument, one must have an “inlay” created in the instrument. Products with custom inlays are referred to as having undergone an “inlay process.” This process can be time consuming, expensive to extremely expensive, and can only be performed one time to the instrument or, if possible at all, modified only for an incredible amount of money.

To achieve an “inlay,” any number of flat or flattenable materials can be inlaid into the surfaces of instruments, but the most popular for stringed instruments has always been mother of pearl from pearl oysters and a similarly-derived material from abalone shells. Several steps are entailed in converting an arched shell to flat sections for inlay “blanks.” The first is to mark the shell (on the inside) to take best advantage of the figure and pattern, and to minimize the arch in any particular rough section (the less arch, the larger and thicker the final blank). The resulting jigsaw puzzle is then bandsawn into arched individual sections that are lined with mother of pearl on one side and with the shell exterior on the other. The rough exterior surface is then ground off to reveal the underlying mother of pearl. The resulting section is anywhere from 1 mm to 25 mm thick (up to 1″ for really thick shells at the lip), and it is still arched. It is heavily tedious to flatten blanks against a normal grinding wheel, and the resulting product is very inconsistent.

The amount of handwork that goes into planning, marking, bandsawing, and preliminary grinding renders the blanks rather expensive, especially for smaller, more difficult material, such as green abalone. One making inlays may be so exposed to the fine dust that results from grinding the shell that one may become ill with silicosis, a potentially fatal lung disease. The finished blanks are characteristically about 1.5 mm-3 mm thick.

The tools necessary for cutting and inlaying pearl include good lighting, a jeweler's saw, a homemade cutting jig, a scribe (with a sharp metal point that is hard and stiff enough to scribe very hard wood), a few needle and small mill files, a dremel moto-tool (or similar high-speed drill) with a dremel router base, various bits and appropriate collets for the dremel, a jig or vise to hold the object to be inlayed, and a 2.5″×5″ or similar rubber sanding block. One method for making organic shell blanks for use in an inlay is disclosed in U.S. Pat. No. 5,776,581.

The jig is c-clamped flat to a table so that the slot and hole extend beyond the edge, the pearl sheet is positioned over the hole, and the wood supports the sheet while the saw cuts downward. The scribe is used to inscribe the exact shape of the inlay into the wood that will be routed for the inlay. A small mill or needle file may be handy for removing the small spur that sometimes remains at the end of the blade path, but otherwise its use is rather limited. One should not rely on a file to clean up roughly-sawn inlay, as the pearl is quite hard and is not easily filed. Just holding an inlay for filing invites breakage.

One must purchase some inlay material, and either purchase or design a pattern to cut. To cut inlay well requires that one be able to carefully follow a line with the jeweler's saw. The pearl is quite hard and it is difficult to hold small, delicate inlays tightly enough to file without breaking.

Once all of the inlays are cut, one must scrutinize them carefully, comparing and matching paired patterns. Once a pattern is inscribed in wood, it is difficult to change. There are also many specific requirements for thickness based on the translucence and relative strength of the material being used.

Inscribing the inlay outline into the wood can also be quite difficult. One must use a scribe to trace around the pattern as close to the edge of the pearl as possible (which should be flush with the edge), but avoid undercutting the pearl, and most of all avoid pushing on the inlay itself with the side of the scribe. Otherwise, there is a risk of dislodging the pearl and/or breaking the inlay. If one is not extremely careful and meticulous, the quality of the final product will suffer. One must then carefully dribble some acetone around each inlay (usually just one or two at a time).

After the acetone has contacted the inlay for a period of minutes, gentle side pressure is used to dislodge it. After each inlay is dislodged, one should clean the residual glue from the inlay bottom and crevices, and renew the label and arrow (the acetone may tend to disperse the pencil marks, and it will dissolve away virtually any ink). One must then arrange the sections carefully to avoid any fitting mistakes attributable to picking up the wrong section during the routing process.

The next step, the three-stage routing process, is the most difficult part of inlay technique. The first stage is to cut the inlay outline deeply with, for example, a pointed dental bit. One then cuts a mortise to about 95% of the thickness of the inlays. If large inlays are being made in a curved surface (D-45 hexagons in a guitar, for example), the mortises will be curved as well unless you shim the bottom of the router base with tape so that it rides perpendicular to the peak of the fingerboard. Once each mortise is examined for any rough edges or uneven lines, they are carefully smoothed with the pointed bit. Next, the inlays are pressed into place. Once all of the inlays are fitted they can be glued into place, and any gaps between the pearl and the mortise edge filled at the same time. The process further includes filling the mortise with a glue/filler, pressing the inlay into place, leveling it, allowing the filler to set up, and filing, scraping, and sanding the inlay flush.

The final steps are to clean up the excess filler and level the inlays with the surrounding wood (e.g., by progressive sanding).

The industry today for the working musician permits flexibility in the look and feel of an inlay (and therefore one's instrument), but not many affordable customization options. A less expensive and simpler method for achieving a customized look would satisfy a long felt need in the art.

### BRIEF SUMMARY OF THE INVENTION

Inlays take an incredible amount of time compared to the installation process of the present invention. It is an object of the present invention to permit one to personalize one's instrument without great expense. It is another object of the present invention to achieve the same look or a far more radical one for a far more feasible price, and the exchangeability lets one customize one's instrument as many times as one wants without purchasing a new instrument or component.

The potential uses for the present invention are broad and can be used with many different instruments as long as the general idea for the application onto the instrument is the same. The applications are for:
a. Aesthetic improvement
b. Tutoring tools
c. Blemish improvement
d. Promotions, Marketing and Advertisement

Another object of the present invention is to permit one to fully customize one's instruments when one wants to and as one sees fit.

The present invention is easier to implement and a less expensive quality substitute for inlays, and have a number of designs, marketing, advertising, and aesthetic possibilities, which can be used on the corporate, or individual level. The potential uses are broad in the imagination of one of ordinary skill in the art.

The invention is for aesthetic uses and miscellaneous applications. The product is a significant improvement over guitar inlays. An object is for aesthetic improvement of the selected instruments, and specific designs can be adapted to the instrument.

The present invention may be produced from various different types vinyl for the aesthetic improvement and customization of the instrument. Other materials included, for example (and not by way of limitation), metal, vinyl, plastic, foil, or simply a thin heat vinyl for printing. The sticker or decal preferably is placed and/or affixed on the neck of the instrument to give the guitar a more diverse feel.

One embodiment of the invention is an overlay that includes a sheet comprising a first substantially flat surface and a second substantially flat surface opposite the first surface, an image disposed on the first surface, an adhesive disposed on the second surface, and a backing layer adjacent, and removably adhered to, the second surface, wherein the sheet comprises a plurality of substantially rectangular-frame forming channels that correspond with the image. For example, the substantially rectangular-frame forming channels may form trapezoids, for example trapezoids that correspond to the portions of the fingerboard between or adjacent to frets on a guitar.

The sheet may optionally include the substantially rectangular-frame forming channels disposed along a longitudinal axis. The plurality of substantially rectangular-frame forming channels form two different sections: fret sections (corresponding to the fret sections of the neck of the instrument (e.g., a guitar neck)) and neck sections (corresponding to the portions of the neck between or adjacent to frets). The neck sections may optionally have a width along the longitudinal axis and a height perpendicular to the longitudinal axis, and the widths become generally larger while moving along the longitudinal axis from a first end of the neck sections to a second end of the neck sections. The heights of the neck sections may optionally become generally smaller while moving along the longitudinal axis from a first end of the neck sections to a second end of the neck sections. The plurality of substantially rectangular-frame forming channels, and the number of neck sections, may vary in number. Preferably, the substantially rectangular-frame forming channels form neck sections that optionally vary in number between 20, 21, 22 and 23 (or another number suitable to the particular instrument). The neck sections may generally be applied to the instrument and the fret sections may optionally be discarded or placed on the frets to make a fully contiguous image, or may be eliminated altogether if the manufacturing process permits.

Yet another embodiment of the invention is an overlay that includes a sheet comprising a plurality of substantially rectangular-frame forming channels that correspond with an image, wherein the channels include slits.

Another embodiment of the invention is an overlay that includes a sheet comprising a plurality of substantially rectangular-frame forming channels that correspond with an image, wherein the channels include grooves.

A still further embodiment of the invention is an overlay that includes a plurality of substantially rectangular-frame forming channels that correspond with an image, wherein the channels include grooves.

Another embodiment of the invention is an overlay that includes a sheet comprising a plurality of substantially rectangular-frame forming perforations that correspond with an image. As with the channels, the plurality of substantially rectangular-frame forming perforations form two different sections: fret sections and neck sections.

Yet another embodiment of the invention further includes a coating to protect the image from degrading.

A still further embodiment of the invention is an overlay that includes a sheet comprising a first substantially flat surface and a second substantially flat surface opposite the first surface, an image disposed on the second surface, an adhesive disposed on the second surface, and a backing layer adjacent, and removably adhered to, the second surface, wherein the sheet comprises a plurality of substantially rectangular-frame forming channels that correspond with the image.

Yet another embodiment of the invention is a method for creating an overlay sheet.

### BRIEF DESCRIPTION OF SEVERAL VIEWS OF THE DRAWINGS

FIG. 1 is a plan view of an overlay sheet according to one embodiment of the present invention.

FIG. 1A is a cross-section of the overlay sheet illustrated in FIG. 1 taken along lines 1A.

FIG. 1B is a partial view of an overlay sheet according to an alternative embodiment of the invention.

FIG. 1C is a partial view of an overlay sheet according to another alternative embodiment of the invention.

FIG. 2 is a perspective view of an overly sheet and a guitar according to yet another embodiment of the present invention.

FIG. 3 is a perspective view of an overlay sheet applied to a guitar according to one embodiment of the present invention.

FIG. 4 is a perspective view of a guitar and overlay sheet according to one embodiment of the present invention.

FIG. 4A is a partial perspective view of an overlay sheet according to one embodiment of the present invention.

FIG. 5 is a partial side view of an overlay being applied to a guitar according to one embodiment of the present invention.

### DETAILED DESCRIPTION OF THE INVENTION

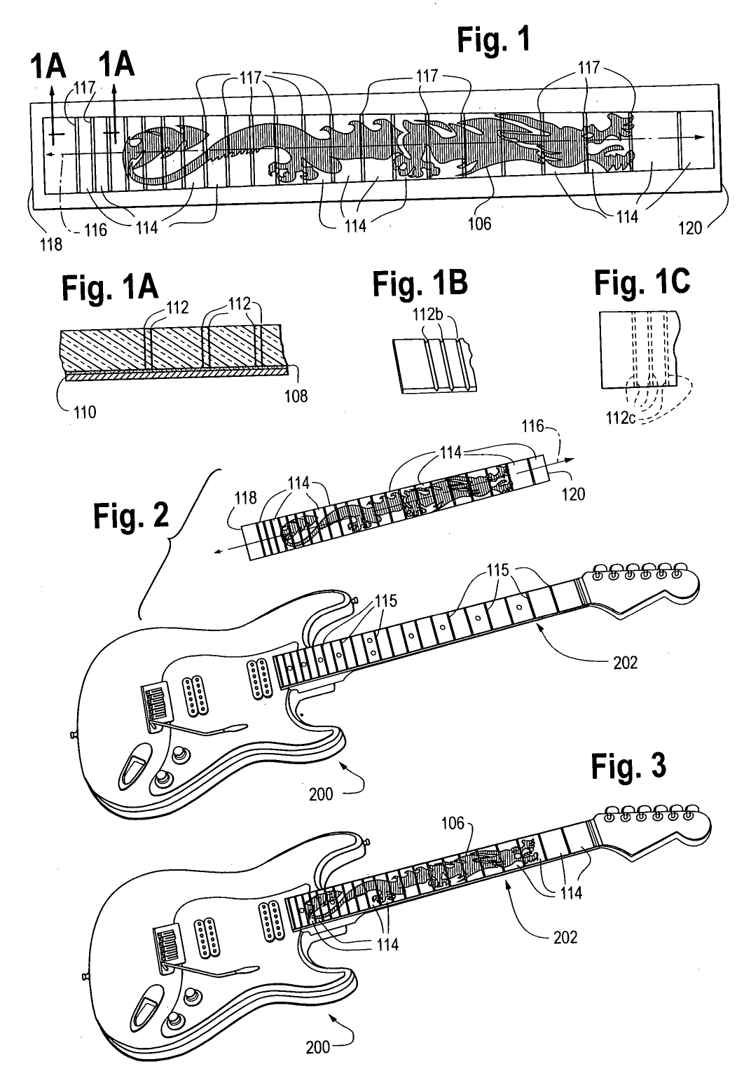

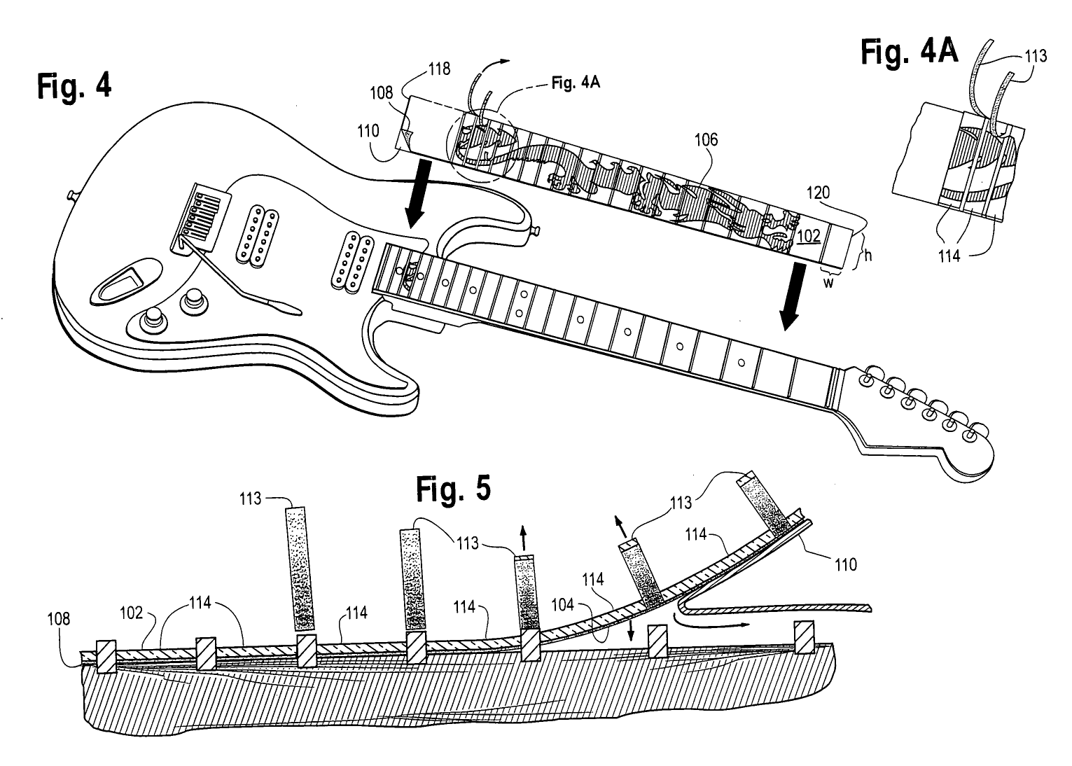

Turning now to FIGS. 1, 4A and 5, the preferred overlay disclosed herein includes a sheet 100 comprising a first substantially flat surface 102 and a second substantially flat surface 104 opposite the first surface 102, an image 106 disposed on the first surface 102, an adhesive 108 disposed on the second surface 104, and a backing layer 110 adjacent, and removably adhered to, the second surface.

The sheet preferably comprises a plurality of substantially rectangular-frame forming channels 112 that correspond with the image 106. The channels form fret sections 113, and substantially rectangular neck sections 114. For example, the substantially rectangular-frame forming channels 112 may form trapezoids, for example trapezoids that correspond to the portions of the fingerboard between or adjacent to frets on a guitar 200.

Turning to FIGS. 2-4, in order to achieve the appearance of an inlay, the neck sections 114 formed by the channels 112 are adhered between the frets 115 on the neck 202 of a guitar 200. In a preferred embodiment, the adhesion is achieved by removing the backing layer 110 and affixing the adhesive side of the sheet 100 to the guitar neck 202.

Any image suitable for inclusion on the neck of the guitar 202 may be appropriate. In the exemplary embodiment depicted in FIGS. 1-4 and 4A, an image of a dragon is shown.

The number of neck sections 114 is determined, for example, by the number of frets on the neck of the guitar 202 and/or the design desired. For example, if 21 frets are included on the guitar 200, the number of neck sections should be 20, or 21 neck sections 114 for 22 frets, 22 neck sections 114 for 23 frets, etc. If one desires to include an image that extends less than the entire distance between the frets, one may include an image that extends over some smaller number of frets (and thus, a smaller number of neck sections 114). The number of neck sections 114 may also be determined by the desired application. Possible applications include, for example, aesthetic improvement (for example, designs), tutoring tools (for example, note indicators), blemish improvement (for example, neck sections 114 that are the same color as the guitar neck 202), and promotions, marketing and advertisement (for example, a product logo).

Turning again to FIG. 1, the substantially rectangular-frame forming channels may also define a plurality of neck sections disposed along a longitudinal axis 116. Further, the plurality of neck sections may have a width w along the longitudinal axis 116 and a height h perpendicular to the longitudinal axis 116. The widths w may become generally larger while moving along the longitudinal axis from a first end 118 of the neck sections to a second end 120 of the neck sections. In one embodiment, the overall width of the 23 neck sections 114 plus the width of the frets 115 totals 18.11″, which is a standard size for guitars having 23 frets. The heights h may also become generally smaller while moving along said longitudinal axis 116 from a first end 118 of said neck sections to a second end 120 of said neck sections. The height of the neck sections 114 may decrease, for example, from a larger height (such as approximately 2.133″) at the first end 118 to a smaller height at the second end 120.

The sheet 100 may preferably be made of a flexible material, such as, for example, vinyl. The present invention may also be produced, however, from various different types of metal, vinyl, plastic, foil, or simply a thin heat vinyl for printing. The portions of the sheet 100 that correspond to the frets, i.e. the fret sections 113, will normally be waste. Alternatively, the space corresponding to the frets may be left blank, and when the second surface 104 is adhered to the backing layer 110, a coating or other covering may be placed on the blank portions to prevent the blank portions from adhering to the undesired objects. In yet another alternative embodiment, the spaces that correspond to the frets may be eliminated altogether and the neck sections 114 may be placed in an abutting relationship to one another.

The image 106 may be disposed on the first surface 102. This may result in the image 106 degrading, being worn away, or becoming discolored over time. Alternatively, therefore, the image 106 may be further protected by the application of a protective coat on top of, or in conjunction with, the image. In yet another alternative embodiment, the image 106 may be applied to the second surface 104 (not shown) to protect the image 106 and to prevent it from degrading (with or without a protective coat, or with the adhesive acting as the protective coat). The color of the design (and the neck sections 114) may be determined by, for example, user preference and/or the application. The desired color of the selected design may determine the design to be used and an application for blemish improvement may cause the desired color(s) to match the color(s) of the guitar's neck 202. In one embodiment, the image lob may contain one or more phosphors so that it glows in the dark, for example to a crowd or a guitarist to see the guitar 200 and frets on a dark stage.

The adhesive 108 is preferably a type that can be removed without damaging the guitar neck's surface. As a result, the overlays can be changed or exchanged over time.

In an alternative embodiment shown in FIG. 1B, the sheet 100 includes a plurality of substantially rectangular-frame forming grooves 112b that correspond with said image 106. Likewise, in another alterative embodiment shown in FIG. 1C, the sheet 100 includes a plurality of substantially rectangular-frame forming perforations 112b that correspond with said image 106. In yet another additional embodiments, the plurality of substantially rectangular-frame forming channels may comprise a plurality of slits, slots or the like (not separately shown) that correspond with said image 106. Whether channels 112 (including slits, slots or the like), grooves 112b, and/or perforations 112c are used to create the substantially rectangular-frames, the channels 112, grooves 112b, and/or perforations 112c enable the user to remove the neck sections 114 from the backing layer 110.

In yet another embodiment, the invention includes a method for creating an overlay sheet comprising applying an image 106 to a first side of a sheet 102, applying adhesive 108 to a second, opposing side of said sheet 104 and stamping, slitting, cutting, or perforating a plurality of substantially rectangular-frame forming neck sections corresponding to the image. In one embodiment, the sheet 102 is fed into a machine similarly to how paper is fed into a “plotter” in the printing art. The machine then cuts the sheet with a razor blade-like device. The method may also include applying a backing layer 110 to the adhesive side of the sheet. The method may alternatively (or additionally) include applying an image to the second surface 104. The method may also include applying a protective coat to whichever separating method is used, the sheet 100 may be the same size as the neck of the guitar 200 (as shown in FIG. 2) or may be larger (as shown in FIG. 1) for ease of manufacture.

While particular embodiments of the invention have been shown, it will be understood, of course, that the invention is not limited thereto since modifications may be made by those skilled in the art, particularly in light of the foregoing teachings. It is, therefore, contemplated that the appended claims will cover any such modifications as incorporate those features that constitute the essential features of these improvements within the true spirit and the scope of the invention.

### SEQUENCE LISTING

Not Applicable

We claim:

1. An overlay comprising:
a sheet comprising a first substantially flat surface and a second substantially flat surface opposite said first surface, and a plurality of substantially rectangular-frame forming channels defining a plurality of neck sections disposed along a longitudinal axis;
an image disposed on said first surface;
an adhesive disposed on said second surface; and
a backing layer adjacent, and removably adhered to, said second surface;
wherein
said plurality of substantially rectangular-frame forming channels correspond with said image;
said plurality of neck sections have a width along said longitudinal axis and a height perpendicular to said longitudinal axis;
said widths become generally larger while moving along said longitudinal axis from a first end of said neck sections to a second end of said neck sections; and
said heights become generally smaller while moving along said longitudinal axis from a first end of said neck sections to a second end of said neck sections.

2. The sheet of claim 1 wherein said plurality of substantially rectangular-frame forming channels forms 20 substantially rectangular neck sections.

3. The sheet of claim 1 wherein said plurality of substantially rectangular-frame forming channels forms 21 substantially rectangular neck sections.

4. The sheet of claim 1 wherein said plurality of substantially rectangular-frame forming channels forms 22 substantially rectangular neck sections.

5. The sheet of claim 1 wherein said plurality of substantially rectangular-frame forming channels forms 23 substantially rectangular neck sections.

6. The sheet of claim 1 wherein said channels comprise slits.

7. The sheet of claim 1 wherein said channels comprise grooves.

8. The sheet of claim 1 wherein said channels comprise slots.

9. The sheet of claim 1 further comprising a protective coating adjacent said first surface.

10. An overlay comprising:
a sheet comprising a first substantially flat surface and a second substantially flat surface opposite said first surface, and a plurality of substantially rectangular-frame forming perforations defining a plurality of neck sections disposed along a longitudinal axis;
an image disposed on said first surface;
an adhesive disposed on said second surface; and
a backing layer adjacent, and removably adhered to, said second surface;
wherein
said plurality of substantially rectangular-frame forming perforations that correspond with said image;
said plurality of neck sections have a width along said longitudinal axis and a height perpendicular to said longitudinal axis;
said widths become generally larger while moving along said longitudinal axis from a first end of said neck sections to a second end of said neck sections; and
said heights become generally smaller while moving along said longitudinal axis from a first end of said neck sections to a second end of said neck sections.

11. The sheet of claim 10 wherein said plurality of substantially rectangular-frame forming perforations forms 20 substantially rectangular neck sections.

12. The sheet of claim 10 wherein said plurality of substantially rectangular-frame forming perforations forms 21 substantially rectangular neck sections.

13. The sheet of claim 10 wherein said plurality of substantially rectangular-frame forming perforations forms 22 substantially rectangular neck sections.

14. The sheet of claim 10 wherein said plurality of substantially rectangular-frame forming perforations forms 23 substantially rectangular neck sections.

15. An overlay comprising:
a sheet comprising a first substantially flat surface and a second substantially flat surface opposite said first surface, and a plurality of substantially rectangular-frame forming channels defining a plurality of neck sections disposed along a longitudinal axis;
an image disposed on said second surface;
an adhesive disposed on said second surface; and
a backing layer adjacent, and removably adhered to, said second surface;
wherein
said plurality of substantially rectangular-frame forming channels correspond with said image;
said plurality of neck sections have a width along said longitudinal axis and a height perpendicular to said longitudinal axis;
said widths become generally larger while moving along said longitudinal axis from a first end of said neck sections to a second end of said neck sections; and
said heights become generally smaller while moving along said longitudinal axis from a first end of said neck sections to a second end of said neck sections.

16. The sheet of claim 15 further comprising a protective coating adjacent said second surface.

17. A method of creating an overlay comprising:
having a first surface of a sheet;
applying an image to said sheet;
applying adhesive to a second surface of said sheet, said second surface of said sheet being disposed opposite said first surface; and
creating a plurality of substantially rectangular-frame neck sections corresponding to the image.

18. The method of claim 17 wherein said applying step comprises applying an image to said first surface of said sheet.

19. The method of claim 18 further comprising applying a backing layer to the second, adhesive surface of said sheet.

20. The method of claim 18 further comprising applying a protective coating to the first surface after said image is applied to said first surface of said sheet.

21. The method of claim 18 wherein said creating step comprises stamping.

22. The method of claim 18 wherein said creating step comprises slicing.

23. The method of claim 18 wherein said creating step comprises cutting.

24. The method of claim 17 wherein said applying step comprises applying an image to said second surface of said sheet.

25. The method of claim 24 further comprising applying a backing layer to the second, adhesive surface of said sheet.

26. The method of claim 24 wherein said creating step comprises stamping.

27. The method of claim 24 wherein said creating step comprises slicing.

28. The method of claim 24 wherein said creating step comprises cutting.
